(19) United States
(12) Patent Application Publication
(10) Pub. No.: US 2023/0222167 A1
(43) Pub. Date: Jul. 13, 2023

(54) SYSTEM, QUERY GENERATION APPARATUS, QUERY GENERATION METHOD, AND NON-TRANSITORY COMPUTER READABLE MEDIUM

(71) Applicant: NEC Corporation, Minato-ku, Tokyo (JP)

(72) Inventors: Kazufumi KOJIMA, Tokyo (JP); Masahiro TANI, Tokyo (JP); Keisuke IKEDA, Tokyo (JP)

(73) Assignee: NEC Corporation, Minato-ku, Tokyo (JP)

(21) Appl. No.: 17/928,223

(22) PCT Filed: May 29, 2020
(86) PCT No.: PCT/JP2020/021363

§ 371 Date: Nov. 28, 2022

(51) Int. Cl. G06F 16/9536; G06Q 50/00

(52) U.S. Cl. CPC G06F 16/9536; G06Q 50/01

(57) ABSTRACT

An account retrieval system (2) includes: a query generation apparatus (100) that generates an account name of a retrieval query based on input account information of an account; and an account collection apparatus (200) that retrieves, by using the retrieval query generated by the query generation apparatus (100), account information of an account name corresponding to the account name of the retrieval query from social media information.

### TECHNICAL FIELD

The present invention relates to a system, a query generation apparatus, a query generation method, and a non-transitory computer readable medium.

### BACKGROUND ART

In recent years, social media such as Social Networking Services (SNSs) have begun to be widely used throughout the world. The number of types of social media has also increased, and about 80% of users have a plurality of accounts on different social media. Therefore, relationships between social media users and accounts used by the users have become diverse, and research related to the above has been conducted.

As a related technique, Non Patent Literature 1 is known. Non Patent Literature 1 discloses that link information of different social media accounts is used to find accounts of the same user. Further, Non Patent Literature 2 is known as a technique related to generation of an account name. In the tool disclosed in Non Patent Literature 2, any account name can be generated based on input user information (name, gender, hometown, etc.).

### CITATION LIST

### Non Patent Literature

Non Patent Literature 1: Waseem Ahmad, Rashid Ali, “A Framework for Seed User Identification across Multiple Online Social Networks”, 2017 International Conference on Advances in Computing, Communications and Informatics (ICACCI), 13-16 Sept. 2017
Non Patent Literature 2: Masterpiece Generator, “Name Generator”, [online], Internet <URL: https://www.name-generator.org.uk/username/>

### SUMMARY OF INVENTION

### Technical Problem

According to the related technique such as Non Patent Literature 1, accounts of the same user can be found by using link information of different social media accounts. However, by the related technique, it is difficult to effectively find accounts used by the same user since other information is not taken into account.

In view of the problem described above, an object of the present disclosure is to provide a system, a query generation apparatus, a query generation method, and a non-transitory computer readable medium that are capable of effectively finding accounts used by the same user.

### Solution to Problem

A system according to the present disclosure includes: query generation means for generating an account name of a retrieval query based on input account information of an account; and account retrieval means for retrieving, by using the generated retrieval query, account information of an account name corresponding to the account name of the retrieval query from social media information.

A query generation apparatus according to the present disclosure includes: account name candidate generation means for generating, based on input account information of an account, a plurality of account name candidates serving as candidates for a retrieval query for retrieving the account information from social media information; and candidate filtering means for filtering the plurality of generated account name candidates based on characteristics of a user of the account acquired from the input account information.

A query generation apparatus according to the present disclosure includes: account name generation means for generating, based on input account information of an account, a plurality of account names serving as retrieval queries for retrieving the account information from social media information; and priority setting means for setting, for the plurality of generated account names, a priority for performing account matching with regard to a result of the retrieval based on characteristics of a user of the account acquired from the input account information.

A query generation apparatus according to the present disclosure includes: characteristic extraction means for extracting, based on input account information of an account, characteristics of a user of the account; and account name generation means for generating, based on the input account information and the extracted characteristics of the user, an account name of a retrieval query for retrieving the account information from social media information.

A query generation method according to the present disclosure includes: generating, based on input account information of an account, a plurality of account name candidates serving as candidates for a retrieval query for retrieving the account information from social media information; and filtering the plurality of generated account name candidates based on characteristics of a user of the account acquired from the input account information.

A query generation method according to the present disclosure includes: generating, based on input account information of an account, a plurality of account names serving as retrieval queries for retrieving the account information from social media information; and setting, for the plurality of generated account names, a priority for performing account matching with regard to a result of the retrieval based on characteristics of a user of the account acquired from the input account information.

A query generation method according to the present disclosure includes: extracting, based on input account information of an account, characteristics of a user of the account; and generating, based on the input account information and the extracted characteristics of the user, an account name of a retrieval query for retrieving the account information from social media information.

A non-transitory computer readable medium according to the present disclosure is a non-transitory computer readable medium storing a program for causing a computer to: generate, based on input account information of an account, a plurality of account name candidates serving as candidates for a retrieval query for retrieving the account information from social media information; and filter the plurality of generated account name candidates based on characteristics of a user of the account acquired from the input account information.

A non-transitory computer readable medium according to the present disclosure is a non-transitory computer readable medium storing a program for causing a computer to: generate, based on input account information of an account, a plurality of account names serving as retrieval queries for retrieving the account information from social media information; and set, for the plurality of generated account names, a priority for performing account matching with regard to a result of the retrieval based on characteristics of a user of the account acquired from the input account information.

A non-transitory computer readable medium according to the present disclosure is a non-transitory computer readable medium storing a program for causing a computer to: extract, based on input account information of an account, characteristics of a user of the account; and generate, based on the input account information and the extracted characteristics of the user, an account name of a retrieval query for retrieving the account information from social media information.

### Advantageous Effects of Invention

According to the present disclosure, it is possible to provide a system, a query generation apparatus, a query generation method, and a non-transitory computer readable medium that are capable of effectively finding accounts used by the same user.

### BRIEF DESCRIPTION OF DRAWINGS

FIG. 1 is a diagram showing a configuration example of an account matching system according to a first example embodiment;

FIG. 2 is a diagram showing a configuration example of an account retrieval system according to the first example embodiment;

FIG. 3 is a diagram showing a configuration example of the account matching system according to the first example embodiment;

FIG. 4 is a flowchart showing an operation example of the account matching system according to the first example embodiment;

FIG. 5 is a diagram showing a configuration example of a query generation apparatus according to a second example embodiment;

FIG. 6 is a diagram showing a configuration example of the query generation apparatus according to the second example embodiment;

FIG. 7 is a flowchart showing an operation example of the query generation apparatus according to the second example embodiment;

FIG. 8 is a diagram showing a configuration example of a query generation apparatus according to a third example embodiment;

FIG. 9 is a diagram showing a configuration example of a query generation apparatus according to a fourth example embodiment;

FIG. 10 is a diagram showing a configuration example of a query generation apparatus according to a fifth example embodiment;

FIG. 11 is a diagram showing a configuration example of a query generation apparatus according to a sixth example embodiment;

FIG. 12 is a diagram showing a configuration example of a query generation apparatus according to a seventh example embodiment;

FIG. 13 is a flowchart showing an operation example of the query generation apparatus according to the seventh example embodiment;

FIG. 14 is a diagram showing a configuration example of a query generation apparatus according to an eighth example embodiment;

FIG. 15 is a flowchart showing an operation example of the query generation apparatus according to the eighth example embodiment; and

FIG. 16 is a block diagram showing an outline of hardware of a computer according to the example embodiments.

### EXAMPLE EMBODIMENT

Example embodiments will be described hereinafter with reference to the drawings. The same elements are denoted by the same reference symbols throughout the drawings, and redundant descriptions will be omitted as necessary.

### Study Conducted Before the Example Embodiments Were Conceived of

Since a technique for specifying, from different social media, accounts (performing matching between accounts) owned by the same user is useful for estimating user attributes, it can be used in marketing, targeted advertising, and criminal investigations.

For example, crimes using cyberspace have increased in recent years, and threats in cyberspace have been considered problematic. Cyberspace is used mainly for the purpose of planning crimes and raising funds for crimes, and it is important to specify persons involved in crimes in cyberspace in order to prevent such crimes from occurring. In an investigation of a crime using cyberspace, it is conceivable that information possibly related to the crime may be collected in cyberspace, a suspicious person may be detected based on the collected information pieces, the suspicious person may be specified from the information in cyberspace, and finally the person may be monitored in the real world. For example, specifying accounts of the same user is effective when a suspicious person is specified from information in cyberspace.

The inventors have examined methods for retrieving accounts of the same user from among different social media accounts and performing matching between the accounts, and have found that it is difficult in the related techniques to effectively retrieve accounts of the same user and perform matching between the accounts. Even when link information of social media accounts is used to perform retrieval by using the technique disclosed in Non Patent Literature 1, it is not possible to retrieve the accounts and perform matching between them when the accounts are not linked. Further, even when an account name is generated from user information and the account is retrieved using the generated account name by using the technique disclosed in Non Patent Literature 2, the number of generated account name candidates is large and thus the number of retrieval targets is huge.

To address the above problem, in the following example embodiments, it is possible to efficiently and effectively retrieve accounts held by the same user from among a huge number of social media accounts and perform matching between them.

### First Example Embodiment

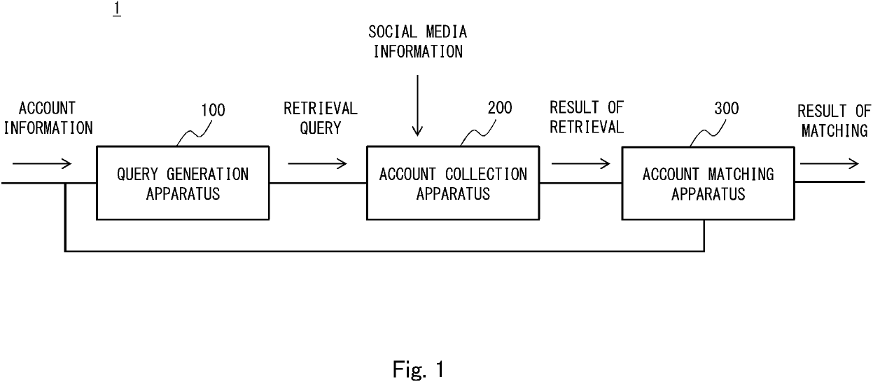

A first example embodiment will be described hereinafter with reference to the drawings. FIG. 1 shows a configuration example of an account matching system according to this example embodiment. The account matching system according to this example embodiment is a system for retrieving accounts owned by the same user as that of an input account and performing matching between the accounts. For example, the account matching system outputs results of matching, whereby it is possible to support crime investigations for law enforcement agencies in various countries, support retail marketing and targeted advertising, and so on.

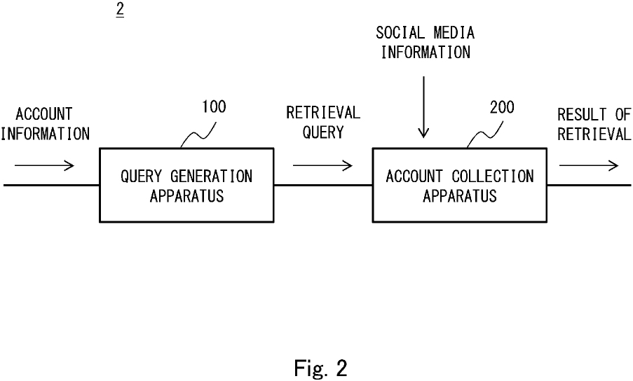

As shown in FIG. 1, an account matching system 1 according to this example embodiment includes a query generation apparatus 100, an account collection apparatus 200, and an account matching apparatus 300. Note that the account matching system 1 is not limited to being composed of these three apparatuses, and may be composed of any number of apparatuses including functions of these apparatuses. For example, as shown in FIG. 2, an account retrieval system 2 including the query generation apparatus 100 and the account collection apparatus 200 may be employed.

The query generation apparatus (query generation unit) 100 generates an account name of a retrieval query based on input account information of an account. For example, the account information may include an account ID, and may further include one or a plurality of account names, profile information, and posted information. The account ID, which is information assigned by a social media system at the time of account registration, is an identifier for identifying the account. The account name, which is information freely set by a user, is a name for identifying the account. The profile information, which is attribute information or an image indicating the profile of a user, is input by the user. For example, the profile information may include the gender, age, date of birth, place of an activity, address, hometown, hobbies, occupation, school, and the like of the user. Note that the account name may be included in the profile information. The posted information is an image, a comment, a conversation, and the like posted by a user on a timeline etc. The account information may include other information related to the account. For example, it may include information indicating connections of the account to other accounts such as accounts of friends and followers on social media.

The account collection apparatus (account retrieval unit) 200 retrieves, by using a retrieval query generated by the query generation apparatus 100, account information of a corresponding account name from social media information. The account matching apparatus (account matching unit) 300 performs matching between each one of a plurality of account information pieces obtained by the retrieval performed by the account collection apparatus 200 and account information input in the query generation apparatus 100.

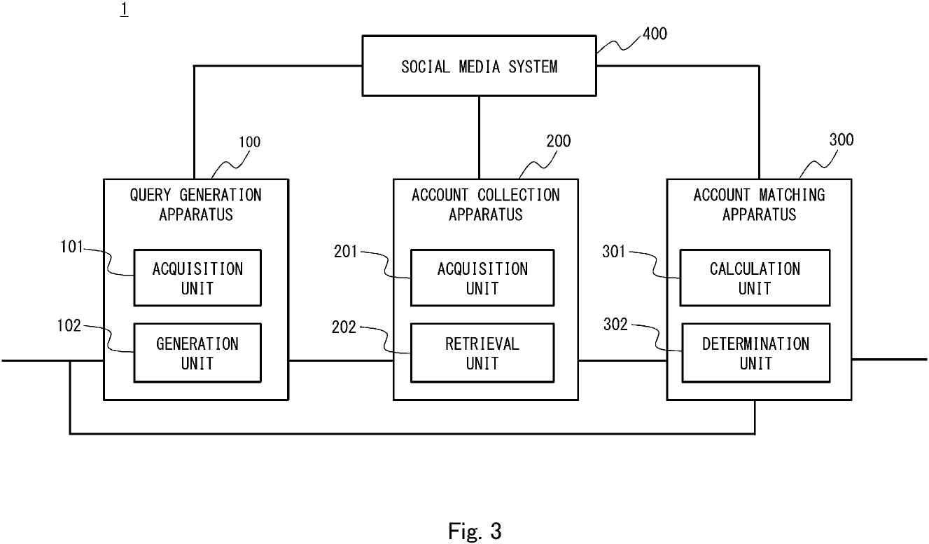

FIG. 3 shows a specific configuration example of the apparatuses of the account matching system according to this example embodiment. For example, the apparatuses of the account matching system 1 are connected to a social media system 400 so that they can communicate with the social media system 400.

The social media system 400 is a system that provides social media services such as SNSs. The social media system 400 includes a plurality of social media services. The social media services are online services that allow a plurality of accounts (users) to transmit (publish) information and communicate with each other on the Internet (online). The social media services include a messaging service such as chat, a blog, an electronic bulletin board, a video sharing site, an information sharing site, and a social media such as a social game or a social bookmark, in addition to SNSs. For example, the social media system 400 includes a server or a user terminal on a cloud. The user terminal inputs and browses posts through an Application Programming Interface (API) provided by a server. The apparatuses of the account matching system 1 may acquire necessary social media information (account information) through a provided API (an acquisition tool) or from a database storing social media information in advance.

The query generation apparatus 100 includes an acquisition unit 101 and a generation unit 102. The acquisition unit 101 is an account information acquisition unit (input unit) that acquires (inputs) account information of an account to be matched (retrieved). The acquisition unit 101 may input an account ID, an account name, profile information, and posted information, or may acquire an account name, profile information, posted information, and the like from the social media system 400 by using the input account ID.

The generation unit 102 generates a retrieval query for retrieving social media information based on the account name, profile information, and posted information included in the acquired (input) account information. The generation unit 102 generates a plurality of account names serving as retrieval queries based on the account name, the profile information, and the posted information of the account.

The account collection apparatus 200 includes an acquisition unit 201 and a retrieval unit 202. The acquisition unit 201 is a social media information acquisition unit that acquires (collects) social media information from the social media system 400. The social media information is public information about each account of the social media, and includes, for each account, account information such as an account ID, an account name, profile information, and posted information. The acquisition unit 201 acquires social media information of a plurality of social media that can be acquired from the social media system 400.

The retrieval unit 202 is an account information retrieval unit that retrieves account information from the acquired social media information by using all generated account names as retrieval queries. Only account information having the same account name as the account name of the retrieval query may be retrieved, or account information having an account name that has a predetermined degree of similarity to the account name of the retrieval query may be retrieved.

The account matching apparatus 300 includes a calculation unit 301 and a determination unit 302. The calculation unit 301 calculates a degree of similarity (a similarity score) between each one of a plurality of account information pieces obtained by the retrieval and the input account information. For example, the calculation unit 301 calculates a degree of similarity including the account name, the profile information, and the posted information included in the account information. The determination unit 302 determines (retrieves) the account information of the same user as the input account information from the plurality of account information pieces obtained by the retrieval based on the calculated degree of similarity.

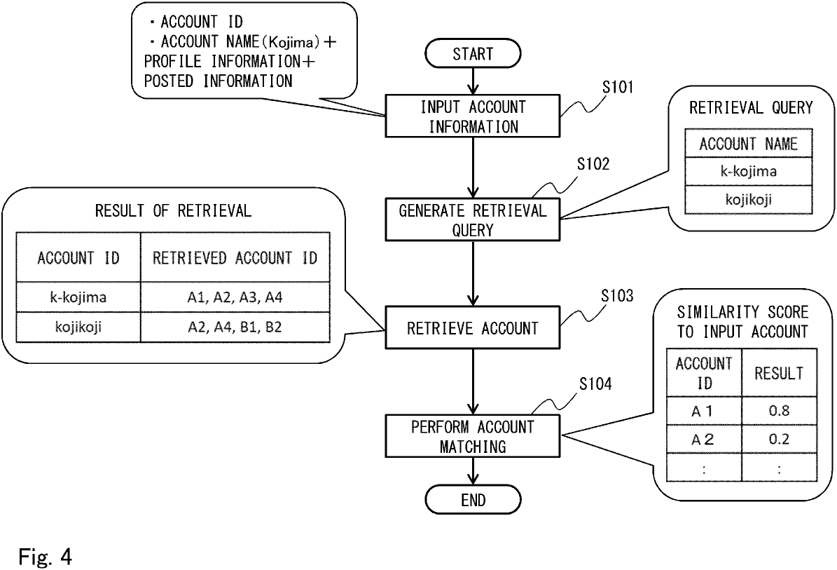

FIG. 4 shows an operation example of the account matching system according to this example embodiment. As shown in FIG. 4, first, the query generation apparatus 100 inputs account information (S101). The acquisition unit 101 inputs (acquires) account information including an account ID, an account name, profile information, and posted information of a social media account to be matched.

Next, the query generation apparatus 100 generates a retrieval query based on the account information (S102). The generation unit 102 generates an account name of the retrieval query based on the input account name, profile information, posted information, and the like. In the example shown in FIG. 4, the generation unit 102 generates account names (k-kojima, kojikoji) as the retrieval queries based on the profile information and the posted information from the input account name (Kojima).

Next, the account collection apparatus 200 retrieves account information from social media information (S103). The acquisition unit 201 acquires social media information of a plurality of social media from the social media system 400, and the retrieval unit 202 retrieves account information of the account names of all the retrieval queries from the acquired social media information. In the example shown in FIG. 4, the account information of account IDs (A1, A2, A3, A4) is retrieved by using the account name (k-kojima) as the retrieval query, and the account information of account IDs (A2, A4, B1, B2) is retrieved by using the account name (kojikoji) as the retrieval query.

Next, the account matching apparatus 300 performs matching with regard to the retrieved account information (S104). The calculation unit 301 calculates a degree of similarity (a similarity score) between each one of a plurality of account information pieces obtained by the retrieval and the input account information, and the determination unit 302 determines account information of the same user as the input account information based on the calculated degree of similarity. For example, when the degree of similarity is higher than a predetermined threshold, it is determined that the account information is the account information of the same user. In the example shown in FIG. 4, the degree of similarity of the account ID=A1 is 0.8, and the degree of similarity of the account ID=A2 is 0.2. For example, when the threshold is 0.5, it is determined that the account ID=A1 is the account of the same user.

As described above, in this example embodiment, a retrieval query is generated in accordance with input account information of an account, whereby support for retrieving other social media accounts owned by the same user is provided. In order to find other social media accounts owned by the same user as that of the input account, it is necessary to retrieve accounts from an infinite number of accounts on the other social media and perform matching between the accounts. However, a collection cost and a calculation cost become high since the number of retrieval targets is huge. Therefore, an account name of a retrieval query is generated based on account information (including, for example, an account name, profile information, and posted information), whereby it is possible to generate an appropriate retrieval query according to the account. Thus, it is possible to reduce the number of other social media accounts to be retrieved, and also possible to reduce both collection and calculation costs.

### Second Example Embodiment

A second example embodiment will be described hereinafter with reference to the drawings. In this example embodiment, an example of the query generation apparatus according to the first example embodiment in which a group of account name candidates is filtered will be described.

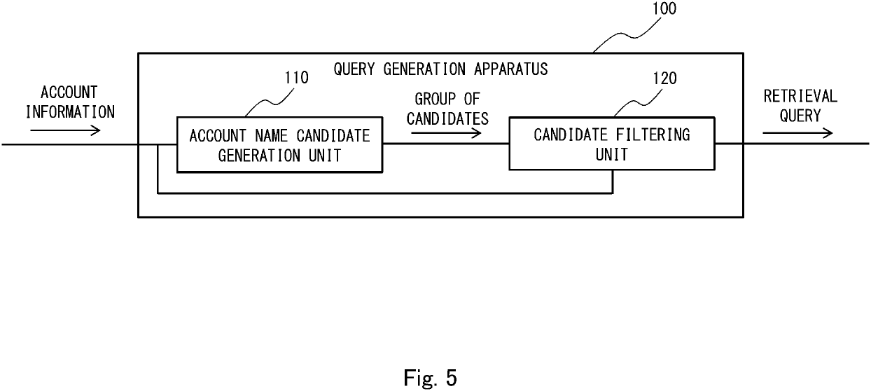

FIG. 5 shows a configuration example of a query generation apparatus according to this example embodiment. The configuration shown in FIG. 5 corresponds, for example, to the generation unit 102 according to the first example embodiment in FIG. 3. As shown in FIG. 5, the query generation apparatus 100 according to this example embodiment includes an account name candidate generation unit 110 and a candidate filtering unit 120.

The account name candidate generation unit 110 generates a group of account name candidates serving as candidates for a retrieval query based on input account information. The account name candidate generation unit 110 generates a plurality of account name candidates from the account name, the profile information, and the posted information included in the input account information.

The candidate filtering unit 120 filters the generated group of account name candidates. The candidate filtering unit 120 filters the group of account name candidates based on the characteristics of a user of an account acquired from the input account information so as to narrow down the number of retrieval queries.

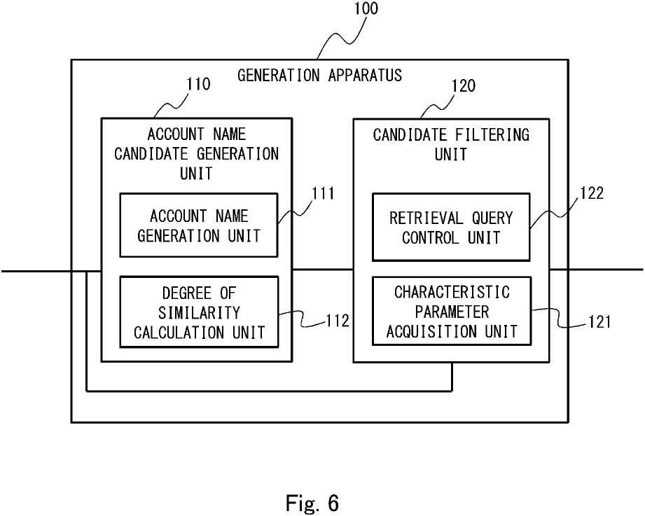

FIG. 6 shows a specific configuration example of each unit of the query generation apparatus according to this example embodiment. As shown in FIG. 6, the account name candidate generation unit 110 includes an account name generation unit 111 and a degree of similarity calculation unit 112.

The account name generation unit 111 generates a plurality of account names based on an account name, profile information, and posted information included in input account information. The degree of similarity calculation unit 112 calculates a degree of similarity (a similarity score) between each one of a plurality of generated account names and the account name of the input account information. The degree of similarity is a score indicating a percentage chance that characters in the respective account names are matched with each other.

The candidate filtering unit 120 includes a characteristic parameter acquisition unit 121 and a retrieval query control unit 122. The characteristic parameter acquisition unit 121 acquires characteristic parameters of a user of an input account. The characteristic parameter acquisition unit 121 acquires characteristic parameters based on profile information and posted information (which may include an account name) included in the input account information. The characteristic parameter is a parameter indicating the characteristic of a user related to the account name.

The retrieval query control unit (filtering control unit) 122 filters a group of account name candidates based on the acquired characteristic parameters. The retrieval query control unit 122 determines a threshold for filtering (threshold for a similarity score) based on characteristic parameters (characteristics of a user), and controls the number of retrieval queries to be output in accordance with the determined threshold. For example, the retrieval query control unit 122 may determine, based on the association between the predetermined characteristic of a user and the threshold, or based on a learning model that has learned a relation between the characteristic of a user and the threshold in advance, the threshold corresponding to the characteristic of the user.

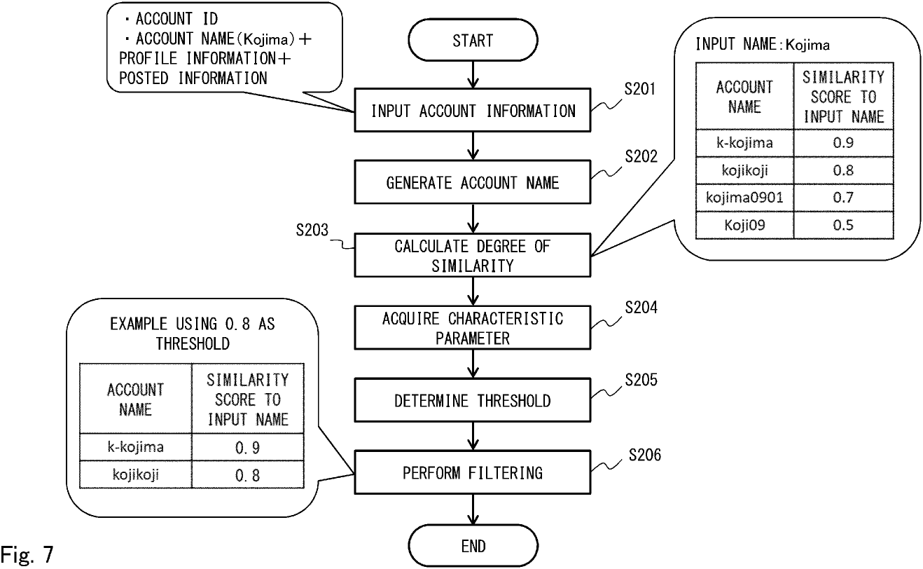

FIG. 7 shows an operation example of the query generation apparatus according to this example embodiment. As shown in FIG. 7, first, the query generation apparatus 100 inputs account information (S201). Like in the case of FIG. 4, account information including an account ID, an account name, profile information, and posted information of a social media account to be matched is input.

Next, the query generation apparatus 100 generates account name candidates (S202). The account name generation unit 111 generates a plurality of account name candidates serving as retrieval queries based on the account name, the profile information, the posted information, and the like included in the input account information. For example, the account name generation unit 111 generates a plurality of account names by combining characters (words) extracted from the profile information (attribute information) and posted information with the account name. In the example shown in FIG. 7, the account name generation unit 111 generates account names (k-kojima, kojikoji, kojima0901, Koji09) based on the profile information and the posted information from the input account name (Kojima).

Next, the query generation apparatus 100 calculates a degree of similarity between the account names (S203). The degree of similarity calculation unit 112 calculates a degree of similarity (a similarity score) between each one of a plurality of generated account names and the account name of the input account information. In the example shown in FIG. 7, the degree of similarity calculation unit 112 calculates a degree of similarity between the input account name (Kojima) and each one of the candidate account names (k-kojima, kojikoji, kojima0901, Koji09).

Next, the query generation apparatus 100 acquires characteristic parameters (S204). The characteristic parameter acquisition unit 121 acquires characteristic parameters based on the profile information and the posted information included in the input account information. For example, the characteristic parameter acquisition unit 121 analyzes characters and images of the profile information and the posted information, and then acquires any characteristic parameters of a user related to the account name based on the features of the analyzed characters and images.

Next, the query generation apparatus 100 determines a threshold for filtering (S205). The retrieval query control unit 122 determines a threshold for filtering (a threshold for a similarity score) based on the acquired characteristic parameters. For example, in accordance with the characteristic parameters, a threshold is set high when a user is likely to use the same account name as the generated account name, while a threshold is set low when a user is unlikely to use the same account name as the generated account name.

Next, the query generation apparatus 100 performs filtering (S206). The retrieval query control unit 122 filters a group of account name candidates in accordance with the determined threshold. In the example shown in FIG. 7, a threshold is set to 0.8, and the account names (k-kojima, kojikoji) having a degree of similarity (a similarity score) of 0.8 or greater are output as retrieval queries, while the account names having a degree of similarity less than 0.8 are not output.

As described above, in this example embodiment, a group of account name candidates is generated from account information including profile information and posted information, and the group of account name candidates is filtered in accordance with the characteristics of a user based on the account information. By doing so, it is possible to properly reduce the total number of retrieval queries in accordance with the characteristics of a user, and it is thus possible to efficiently retrieve accounts of the same user.

### Third Example Embodiment

A third example embodiment will be described hereinafter with reference to the drawings. In this example embodiment, an example of the candidate filtering unit of the query generation apparatus according to the second example embodiment in which a degree of information literacy is calculated will be described.

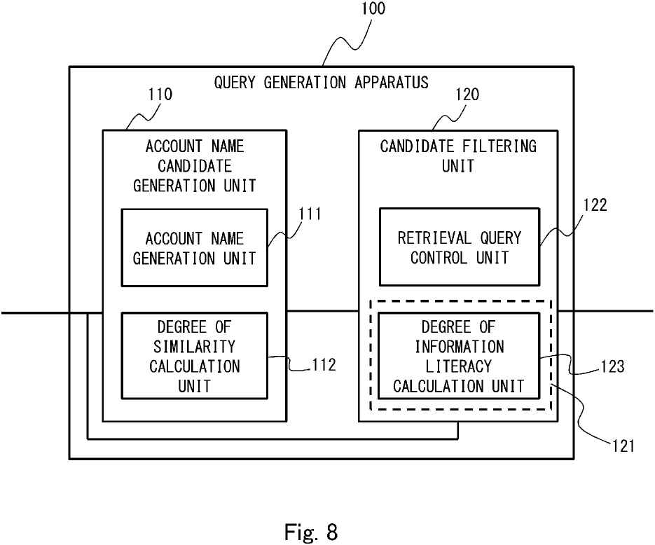

FIG. 8 shows a configuration example of the query generation apparatus 100 according to this example embodiment. As shown in FIG. 8, in this example embodiment, a degree of information literacy calculation unit 123 is provided as the characteristic parameter acquisition unit 121 of the candidate filtering unit 120.

The degree of information literacy calculation unit 123 calculates a degree of information literacy of a user as the characteristic parameter of the user. The degree of information literacy (degree of information disclosure) is a score indicating the level of information disclosure of a user himself/herself on social media.

It is considered that users who post detailed profiles, selfie images, and personal information of themselves (such as whether or not there is Global Positioning System (GPS) information, relationships with friends, and activity histories) have low information literacy. Therefore, a score of the degree of information literacy is calculated, for example, based on the following literacy elements. For example, it may be calculated based on the sum of numerical values of the literacy elements, or it may be calculated based on an average value of numerical values of the literacy elements. Further, one of the elements may be used for this calculation, or any plurality of the elements may be used therefor. Note that the above literacy elements are merely examples, and a degree of information literacy including other elements (frequency of posting, a publication range of posts, etc.) may be obtained.
Percentage of items in profile information filled out
Percentage of selfie images (images of a person that match images of a user or profile image) included in a plurality of posted images
Number of posted information items to which GPS information (location information) has been added
Number of persons who frequently appear in the plurality of posted images (the number of persons who appear a plurality of times)

In this example embodiment, the retrieval query control unit 122 determines a threshold for filtering in accordance with a calculated degree of information literacy. Users having a low degree of information literacy are likely to use common account names, while users having a high degree of information literacy are likely to use different account names. Therefore, a threshold is set high when the degree of information literacy is low, while a threshold is set low when the degree of information literacy is high.

The retrieval query control unit 122 may, for example, associate the relationship between the degree of information literacy and the threshold with a table or the like in advance, and determine the threshold based on this association. Further, the relationship between the literacy element of the degree of information literacy and the threshold may be associated with a table or the like. For example, the degree of information literacy calculation unit 123 may output information indicating that conditions of the respective literacy elements are satisfied (or not satisfied), and the retrieval query control unit 122 may set a threshold in accordance with the number of literacy elements satisfying the respective conditions.

Further, the retrieval query control unit 122 may, for example, generate a learning model that has learned the relationship between the degree of information literacy and the threshold in advance, and determine the threshold based on this learning model. Furthermore, the learning model may learn the relationship between the literacy element of the degree of information literacy and the threshold. For example, the degree of information literacy calculation unit 123 outputs a value of the literacy element, assigns a threshold label to this literacy element, and performs machine learning, thereby generating a learning model. By inputting the value of the literacy element into the trained learning model, a threshold corresponding to the degree of information literacy can be obtained.

As described above, in this example embodiment, a score representing the degree of information literacy of a user is calculated as a characteristic parameter of the user based on profile information and posted information described in the account, and the number of retrieval queries is controlled in accordance with the calculated degree of information literacy. By doing so, it is possible to appropriately narrow down the number of account name candidates in accordance with the degree of information disclosure of a user himself/herself.

### Fourth Example Embodiment

A fourth example embodiment will be described hereinafter with reference to the drawings. In this example embodiment, an example of the candidate filtering unit of the query generation apparatus according to the second example embodiment in which a degree of fame is acquired will be described.

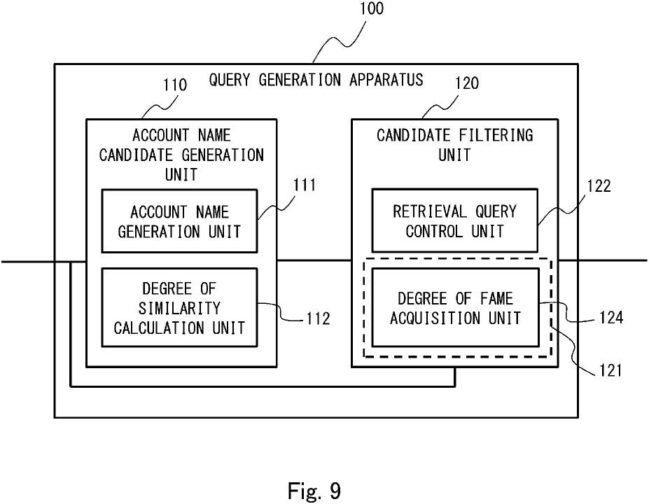

FIG. 9 shows a configuration example of the query generation apparatus 100 according to this example embodiment. As shown in FIG. 9, in this example embodiment, a degree of fame acquisition unit 124 is provided as the characteristic parameter acquisition unit 121 of the candidate filtering unit 120.

The degree of fame acquisition unit 124 acquires the fame of an account (a user) as a characteristic parameter of the user. The degree of fame is a score based on how well an account is recognized by other users (accounts).

For example, the degree of fame is based on the number of friends the account has on social media, the number of followers the account has on social media, the number of responses (retweets, “likes”) made by accounts other than that of the user to posts of the user on social media, and the like. Further, in the case of an official account officially certified by social media, the degree of fame may be set high. The degree of fame may be calculated from the above information pieces or may be acquired from outside.

In this example embodiment, the retrieval query control unit 122 determines a threshold for filtering in accordance with an acquired degree of fame. The more famous a user is, the harder it is to change his/her account name, in order to increase his/her account’s recognition. Therefore, a threshold is set high when the degree of fame is high, while a threshold is set low when the degree of fame is low.

Like in the case of the third example embodiment, the retrieval query control unit 122 may associate the relationship between the degree of fame and the threshold with a table or the like in advance, and determine the threshold based on this association, or may generate a learning model that has learned the relationship between the degree of fame and the threshold in advance, and determine the threshold based on this learning model.

As described above, in this example embodiment, a score representing the degree of fame of an account (a user) is acquired as a characteristic parameter of the user, and the number of retrieval queries is controlled in accordance with the acquired degree of fame. By doing so, it is possible to appropriately narrow down the number of account name candidates in accordance with the degree of fame of the account (the user).

### Fifth Example Embodiment

A fifth example embodiment will be described hereinafter with reference to the drawings. In this example embodiment, an example of the candidate filtering unit of the query generation apparatus according to the second example embodiment in which a name usage rate is acquired will be described.

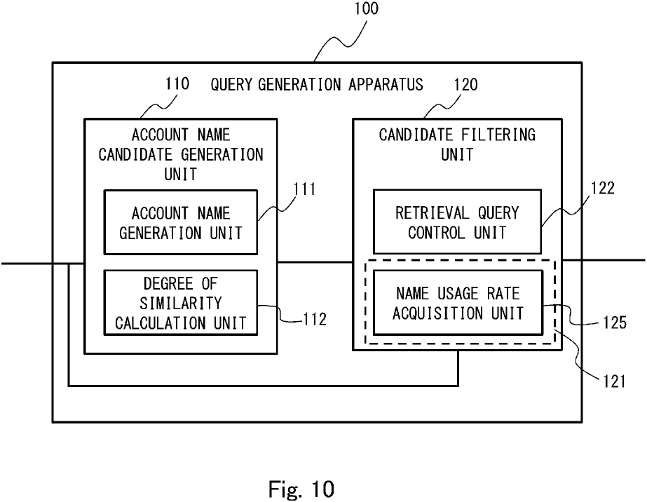

FIG. 10 shows a configuration example of the query generation apparatus 100 according to this example embodiment. As shown in FIG. 10, in this example embodiment, a name usage rate acquisition unit 125 is provided as the characteristic parameter acquisition unit 121 of the candidate filtering unit 120.

The name usage rate acquisition unit 125 acquires a name usage rate of a user as a characteristic parameter of the user. The name usage rate is a percentage chance (level of probability) that the name of a user is commonly used.

For example, the name usage rate is based on the percentage chance that the name is used as a name included in social media account information, the percentage chance that the name is used as a name published on the Internet, and the percentage chance that the name is acquired from name statistical information. The name usage rate may be calculated from the above information pieces or may be acquired from outside.

In this example embodiment, the retrieval query control unit 122 determines a threshold for filtering in accordance with an acquired name usage rate. In the case of the name (i.e., Suzuki, Tanaka, etc.) which too many users use, there is a tendency to substitute a name other than such common names as the account name. Therefore, a threshold is set low when the name usage rate is high, while a threshold is set high when the name usage rate is low.

Like in the case of the third example embodiment, the retrieval query control unit 122 may associate the relationship between the name usage rate and the threshold with a table or the like in advance, and determine the threshold based on this association, or may generate a learning model that has learned the relationship between the name usage rate and the threshold in advance, and determine the threshold based on this learning model.

As described above, in this example embodiment, a score representing the name usage rate of a user is acquired as a characteristic parameter of the user, and the number of retrieval queries is controlled in accordance with the acquired usage rate. By doing so, it is possible to appropriately narrow down the number of account name candidates in accordance with the name usage rate of the user.

### Sixth Example Embodiment

A sixth example embodiment will be described hereinafter with reference to the drawings. In this example embodiment, an example of the candidate filtering unit of the query generation apparatus according to the second example embodiment in which a characteristic vector is extracted will be described.

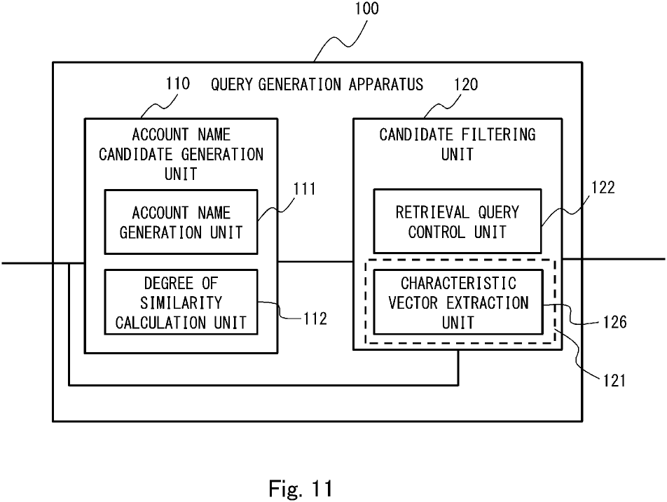

FIG. 11 shows a configuration example of the query generation apparatus 100 according to this example embodiment. As shown in FIG. 11, in this example embodiment, a characteristic vector extraction unit 126 is provided as the characteristic parameter acquisition unit 121 of the candidate filtering unit 120. The characteristic vector extraction unit 126 is vector information indicating characteristics of a user based on profile information and posted information.

A characteristic vector of a user includes a plurality of characteristic elements related to the characteristics of the user. For example, the characteristic elements include an element of the above-described degree of information literacy, and further include other elements. The characteristic elements include any plurality of elements, for example, attribute information (information indicating the attribute of profile information) such as gender, age, and place of residence of a user, the percentage of items in the profile information filled out, the percentage of selfie images included in a plurality of posted images, the number of posts to which GPS information has been added, and the number of persons who frequently appear in the plurality of posted images. The characteristic elements may be other elements obtained from profile information and posted information.

In this example embodiment, the retrieval query control unit 122 determines a threshold for filtering in accordance with an extracted characteristic vector. The retrieval query control unit 122 may control a group of retrieval query candidates based on the similarity score between the characteristic vector of a user and a group of account name candidates. Further, the relationship between the characteristic element of the characteristic vector and the threshold may be learned. For example, a label of the threshold is assigned to the characteristic element extracted by the characteristic vector extraction unit 126 and then machine learning is performed, whereby a learning model is generated. A threshold corresponding to the characteristic vector can be obtained by inputting the characteristic elements to the trained learning model.

As described above, in this example embodiment, a characteristic vector obtained from profile information and posted information is extracted as a characteristic parameter of a user, and the number of retrieval queries is controlled in accordance with the extracted characteristic vector. By doing so, it is possible to appropriately narrow down the number of account name candidates in accordance with the characteristics of the user.

### Seventh Example Embodiment

A seventh example embodiment will be described hereinafter with reference to the drawings. In this example embodiment, an example of the query generation apparatus according to the first example embodiment in which priorities of a plurality of account names are determined will be described.

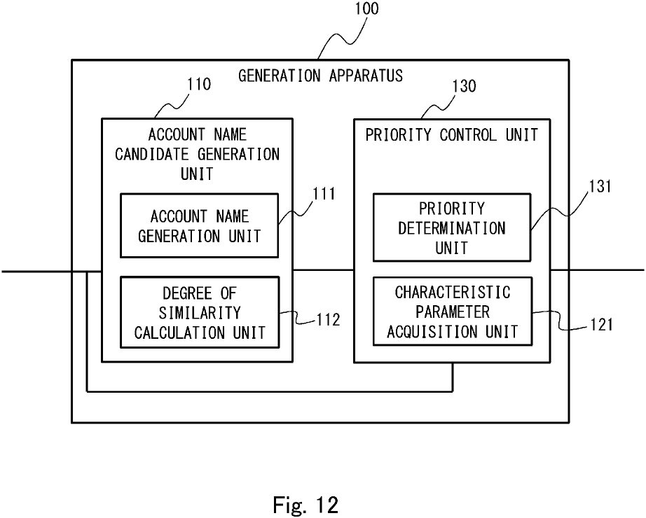

FIG. 12 shows a configuration example of a query generation apparatus according to this example embodiment. The configuration shown in FIG. 12 corresponds, for example, to the generation unit 102 according to the first example embodiment in FIG. 3. As shown in FIG. 12, the query generation apparatus 100 according to this example embodiment includes the account name candidate generation unit 110 and a priority control unit 130. Note that the configuration of the account name candidate generation unit 110 is similar to that of the account name candidate generation unit 110 according to the second example embodiment.

The priority control unit (priority setting unit) 130 controls (sets) a priority of a generated group of account name candidates. The priority is a priority (order of priority) for the account matching apparatus 300 to perform account matching processing.

The priority control unit 130 includes the characteristic parameter acquisition unit 121 and a priority determination unit 131. The configuration of the characteristic parameter acquisition unit 121 is similar to that of the characteristic parameter acquisition unit 121 according to the second to the sixth example embodiments. The priority determination unit 131 determines priorities of a plurality of account names serving as retrieval queries based on acquired characteristic parameters (the characteristics of a user). Like in the case of the threshold for filtering according to the second to the sixth example embodiments, the priority may be determined based on the association between the predetermined characteristic of a user and the priority, or may be determined based on a learning model that has learned the association between the characteristic of a user and the threshold in advance.

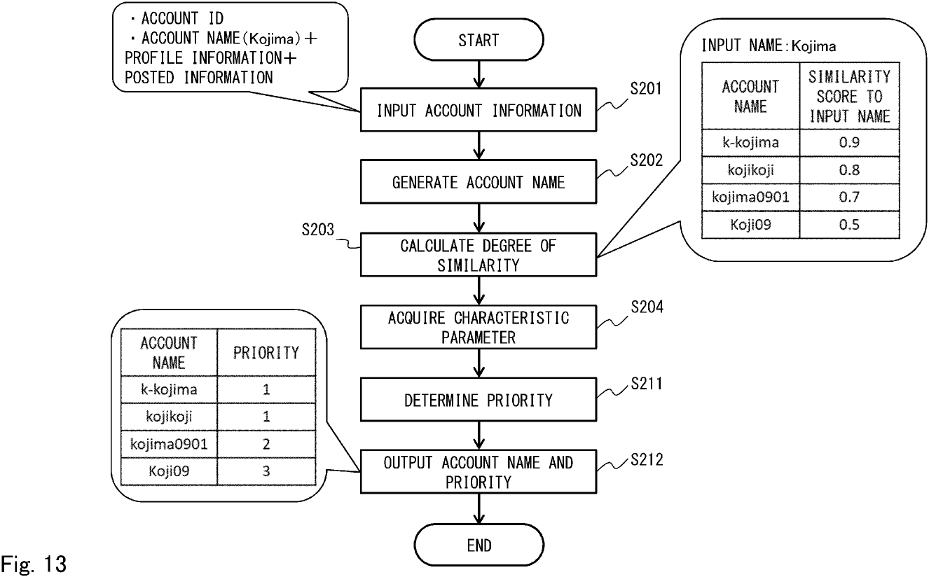

FIG. 13 shows an operation example of the query generation apparatus according to this example embodiment. Steps S201 to S204 are similar to those shown in FIG. 7 according to the second example embodiment. In this example embodiment, when the characteristic parameters are acquired (S204), the priority determination unit 131 determines the priorities of account names serving as retrieval queries based on the acquired characteristic parameters (S211). Next, the priority determination unit 131 outputs a plurality of account names together with the determined priorities thereof (S212). In the example shown in FIG. 13, the priority of the account name having a similarity of 0.8 or greater is set to the highest one, and the priority of the account name having a similarity of less than 0.8 is set to the lowest one.

After that, the account collection apparatus 200 performs retrieval by using the account names, and the account matching apparatus 300 performs matching based on the priorities. The account matching apparatus 300 performs matching between the account information obtained by the retrieval and the input account information in a descending order of priority in which the retrieval queries are arranged from one having the highest priority to one having the lowest priority. For example, when the account information satisfying a criterion of the degree of similarity is detected, matching processing is ended. By doing so, it is possible to improve the speed of matching processing.

As described above, in this example embodiment, a priority of a group of account name candidates is determined in accordance with the characteristics of a user, and account matching is performed based on the priority. By doing so, it is possible to efficiently reliably perform account matching.

### Eighth Example Embodiment

An eighth example embodiment will be described hereinafter with reference to the drawings. In this example embodiment, an example of the query generation apparatus according to the first example embodiment in which account names are generated in accordance with the characteristics of a user will be described.

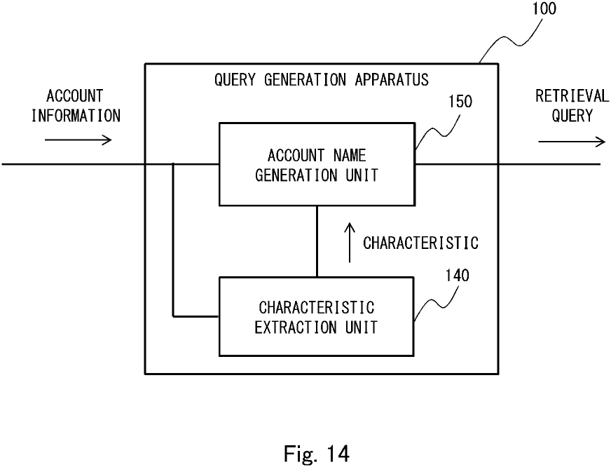

FIG. 14 shows a configuration example of a query generation apparatus according to this example embodiment. The configuration shown in FIG. 14 corresponds, for example, to the generation unit 102 according to the first example embodiment in FIG. 3. As shown in FIG. 14, the query generation apparatus 100 according to this example embodiment includes a characteristic extraction unit 140 and an account name generation unit 150. Note that, like in the cases of the second to the sixth example embodiments, a filtering unit that filters a plurality of account names may be further provided.

The characteristic extraction unit 140 extracts characteristic information of a user based on profile information and posted information (which may include an account name) included in input account information. The account name generation unit 150 generates an account name of a retrieval query based on the extracted characteristic information of the user. The account name generation unit 150 generates an account name while taking into account the profile information and the posted information (contents and trends of the posts). For example, the account name generation unit 150 may take the characteristics of social media used for the retrieval into account.

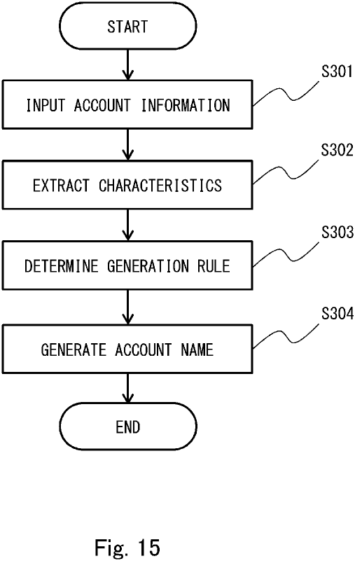

FIG. 15 shows an operation example of the query generation apparatus according to this example embodiment. As shown in FIG. 15, first, the query generation apparatus 100 inputs account information (S301). Like in the case of FIG. 4, account information including an account ID, an account name, profile information, and posted information of a social media account to be matched is input.

Next, the query generation apparatus 100 extracts the characteristics of a user (S302). The characteristic extraction unit 140 extracts characteristic information of the user based on the profile information and the posted information included in the input account information. The characteristic information may include characteristic parameters similar to those in the second to the sixth example embodiments, or may include information indicating other characteristics.

Next, the query generation apparatus 100 determines a generation rule for generation of account names (S303). The account name generation unit 150 determines the generation rule for generation of account names based on the extracted characteristic information of the user. The generation rule is a combination method by which characters and words are combined to generate account names. For example, words to be combined are a word included in attribute information (profile information) of a user, a word frequently used in posted information, and a co-occurrence word (a word having a high degree of co-occurrence) estimated from account information. The combination method is a method of, for example, adding “-” or “_”.

For example, it is possible to analogize a co-occurrence word and the like from profile information (hobbies etc.) and posted information of a user. A learning model may be generated by assigning a label of a co-occurrence word to profile information and posted information (characteristic information) in advance and then performing machine learning, and then the profile information and the posted information (characteristic information) are input to the trained learning model, whereby a co-occurrence word may be estimated. Similarly, a learning model is generated by assigning a label of the account name to which “-” or “_” has been added to profile information and posted information (characteristic information) in advance, and then profile information and posted information (characteristic information) is input to the trained learning model, whereby addition of “-” or “_” may be estimated. Note that, it is not limited to generating a learning model, characters and words to be used may be associated with characteristic information in advance.

Next, the query generation apparatus 100 generates an account name in accordance with the determined generation rule (S304). For example, when it is estimated from the characteristic information (account information) of a user that “-” or “_” is added to the account name, the account name generation unit 150 generates an account name of the retrieval query by using “-” or “_” for the input account name. Further, the account name generation unit 150 generates an account name by combining attribute information of a user, a word frequently used, and a co-occurrence word with each other. For example, when a user’s hobby is baseball and his/her place of residence is Tokyo, it is estimated that “Giants (registered trademark)” is a co-occurrence word, and “Giants” is combined with the input account name, to thereby generate an account name of the retrieval query.

As described above, in this example embodiment, an account name of a retrieval query is generated based on the characteristics of a user such as profile information, and contents and trends of posts. By doing so, it is possible to generate a more appropriate account name in accordance with the characteristics of a user, and it is thus possible to efficiently retrieve accounts of the same user.

Note that the present disclosure is not limited to the above-described example embodiments and may be changed as appropriate without departing from the spirit of the present disclosure. For example, not only the account name but instead other account information may be used as a retrieval query.

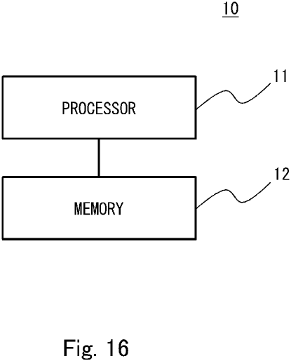

Each component in the above-described example embodiments may be configured by software, hardware, or both of them, and may be configured by one piece of hardware or software, or a plurality of pieces of hardware or software. Each apparatus and each function (processing) may be implemented by a computer 10 including a processor 11 such as a Central Processing Unit (CPU) and a memory 12 as a storage device as shown in FIG. 16. For example, a program for performing the method (the method in each apparatus) according to the example embodiments may be stored in the memory 12, and each function may be implemented by having the processor 11 execute the program stored in the memory 12.

The above programs can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), CD-ROM (Read Only Memory), CD-R, CD-R/W, and semiconductor memories (such as mask ROM, PROM (Programmable ROM), EPROM (Erasable PROM), flash ROM, RAM (random access memory), etc.). The programs may be provided to a computer using any type of transitory computer readable media. Examples of transitory computer readable media include electric signals, optical signals, and electromagnetic waves. Transitory computer readable media can provide the programs to a computer via a wired communication line (e.g., electric wires, and optical fibers) or a wireless communication line.

Although the present disclosure has been described above with reference to example embodiments, the present disclosure is not limited to the above-described example embodiments. Various changes that can be understood by those skilled in the art can be made to the configuration and details of the present disclosure within the scope of the disclosure.

The whole or part of the example embodiments disclosed above can be described as, but not limited to, the following supplementary notes.

### Supplementary Note 1

A system comprising:
query generation means for generating an account name of a retrieval query based on input account information of an account; and
account retrieval means for retrieving, by using the generated retrieval query, account information of an account name corresponding to the account name of the retrieval query from social media information.

### Supplementary Note 2

The system according to Supplementary note 1, wherein the account information includes an account name, profile information, and posted information.

### Supplementary Note 3

The system according to Supplementary note 1 or 2, wherein the query generation means comprises:
account name candidate generation means for generating a plurality of account name candidates serving as candidates for the retrieval query based on the input account information; and
candidate filtering means for filtering the plurality of generated account name candidates based on characteristics of a user of the account acquired from the input account information.

### Supplementary Note 4

The system according to Supplementary note 3, wherein
the account name candidate generation means generates the plurality of account name candidates and calculates a degree of similarity between each one of the plurality of account name candidates and the account name of the input account information, and
the candidate filtering means determines a threshold for filtering based on the characteristics of the user.

### Supplementary Note 5

The system according to Supplementary note 4, wherein the candidate filtering means determines, based on association between a predetermined characteristic of the user and the threshold, the threshold corresponding to the characteristic of the user.

### Supplementary Note 6

The system according to Supplementary note 4, wherein the candidate filtering means determines, based on a learning model that has been learned a relation between the characteristic of the user and the threshold in advance, the threshold corresponding to the characteristic of the user.

### Supplementary Note 7

The system according to any one of Supplementary notes 3 to 6, wherein the candidate filtering means comprises:
characteristic parameter acquisition means for acquiring characteristic parameters indicating the characteristics of the user based on the input account information; and
filtering control means for filtering the plurality of account name candidates based on the acquired characteristic parameters.

### Supplementary Note 8

The system according to Supplementary note 7, wherein the characteristic parameter acquisition means calculates, as the characteristic parameter, a degree of information literacy indicating a level of information disclosure of the user.

### Supplementary Note 9

The system according to Supplementary note 8, wherein the degree of information literacy is based on a percentage of items in the profile information filled out, a percentage of images of the user included in a plurality of posted images, the number of posted information items to which position information has been added, or the number of persons who appear in the plurality of posted images a plurality of times.

### Supplementary Note 10

The system according to Supplementary note 7, wherein the characteristic parameter acquisition means acquires a degree of fame of the user as the characteristic parameter.

### Supplementary Note 11

The system according to Supplementary note 10, wherein the degree of fame is based on the number of friends the user has on social media, the number of followers the user has on social media, or the number of responses made by accounts other than that of the user to posts of the user on social media.

### Supplementary Note 12

The system according to Supplementary note 7, wherein the characteristic parameter acquisition means acquires a name usage rate of the user as the characteristic parameter.

### Supplementary Note 13

The system according to Supplementary note 12, wherein the name usage rate is based on a percentage chance that the name is used as a name included in social media account information, a percentage chance that the name is used as a name published on the Internet, or a percentage chance that the name is acquired from name statistical information.

### Supplementary Note 14

The system according to Supplementary note 7, wherein the characteristic parameter acquisition means extracts, as the characteristic parameter, a characteristic vector indicating the characteristic of the user by a plurality of elements.

### Supplementary Note 15

The system according to Supplementary note 14, wherein the plurality of elements of the characteristic vector include information indicating an attribute of the profile information, a percentage of items in the profile information filled out, a percentage of images of the user included in a plurality of posted images, the number of posted information items to which position information has been added, or the number of persons who appear in the plurality of posted images a plurality of times.

### Supplementary Note 16

The system according to Supplementary note 14 or 15, wherein the filtering control means filters the plurality of account name candidates based on the plurality of elements of the extracted characteristic vector.

### Supplementary Note 17

The system according to Supplementary note 1 or 2, wherein the query generation means comprises:
account name generation means for generating, based on the input account information, a plurality of account names each of which serves as the retrieval query; and
priority setting means for setting, for the plurality of generated account names, a priority for performing account matching with regard to a result of the retrieval based on the characteristics of the user of the account acquired from the input account information.

### Supplementary Note 18

The system according to Supplementary note 1 or 2, wherein the query generation means comprises:
characteristic extraction means for extracting the characteristics of the user of the account based on the input account information; and
account name generation means for generating an account name of the retrieval query based on the input account information and the extracted characteristics of the user.

### Supplementary Note 19

The system according to Supplementary note 18, wherein the account name generation means determines a generation rule for generating the account name based on the extracted characteristics of the user, and generates the account name based on the determined generation rule.

### Supplementary Note 20

The system according to Supplementary note 19, wherein the generation rule includes a rule using a co-occurrence word estimated from the characteristics of the user.

### Supplementary Note 21

The system according to Supplementary note 20, wherein the co-occurrence word corresponding to the characteristic of the user is estimated based on a learning model that has learned a relation between the characteristic of the user and the co-occurrence word in advance.

### Supplementary Note 22

A query generation apparatus comprising:
account name candidate generation means for generating, based on input account information of an account, a plurality of account name candidates serving as candidates for a retrieval query for retrieving the account information from social media information; and
candidate filtering means for filtering the plurality of generated account name candidates based on characteristics of a user of the account acquired from the input account information.

### Supplementary Note 23

The query generation apparatus according to Supplementary note 22, wherein the account information includes an account name, profile information, and posted information.

### Supplementary Note 24

A query generation apparatus comprising:
account name generation means for generating, based on input account information of an account, a plurality of account names serving as retrieval queries for retrieving the account information from social media information; and
priority setting means for setting, for the plurality of generated account names, a priority for performing account matching with regard to a result of the retrieval based on characteristics of a user of the account acquired from the input account information.

### Supplementary Note 25

The query generation apparatus according to Supplementary note 24, wherein the account information includes an account name, profile information, and posted information.

### Supplementary Note 26

A query generation apparatus comprising:
characteristic extraction means for extracting, based on input account information of an account, characteristics of a user of the account; and
account name generation means for generating, based on the input account information and the extracted characteristics of the user, an account name of a retrieval query for retrieving the account information from social media information.

### Supplementary Note 27

The query generation apparatus according to Supplementary note 26, wherein the account information includes an account name, profile information, and posted information.

### Supplementary Note 28

A query generation method comprising:
generating, based on input account information of an account, a plurality of account name candidates serving as candidates for a retrieval query for retrieving the account information from social media information; and
filtering the plurality of generated account name candidates based on characteristics of a user of the account acquired from the input account information.

### Supplementary Note 29

The query generation method according to Supplementary note 28, wherein the account information includes an account name, profile information, and posted information.

### Supplementary Note 30

A query generation method comprising:
generating, based on input account information of an account, a plurality of account names serving as retrieval queries for retrieving the account information from social media information; and
setting, for the plurality of generated account names, a priority for performing account matching with regard to a result of the retrieval based on characteristics of a user of the account acquired from the input account information.

### Supplementary Note 31

The query generation method according to Supplementary note 30, wherein the account information includes an account name, profile information, and posted information.

### Supplementary Note 32

A query generation method comprising:
extracting, based on input account information of an account, characteristics of a user of the account; and
generating, based on the input account information and the extracted characteristics of the user, an account name of a retrieval query for retrieving the account information from social media information.

### Supplementary Note 33

The query generation method according to Supplementary note 32, wherein the account information includes an account name, profile information, and posted information.

### Supplementary Note 34

A non-transitory computer readable medium storing a program for causing a computer to:
generate, based on input account information of an account, a plurality of account name candidates serving as candidates for a retrieval query for retrieving the account information from social media information; and
filter the plurality of generated account name candidates based on characteristics of a user of the account acquired from the input account information.

### Supplementary Note 35

The non-transitory computer readable medium according to Supplementary note 34, wherein the account information includes an account name, profile information, and posted information.

### Supplementary Note 36

A non-transitory computer readable medium storing a program for causing a computer to:
generate, based on input account information of an account, a plurality of account names serving as retrieval queries for retrieving the account information from social media information; and
set, for the plurality of generated account names, a priority for performing account matching with regard to a result of the retrieval based on characteristics of a user of the account acquired from the input account information.

### Supplementary Note 37

The non-transitory computer readable medium according to Supplementary note 36, wherein the account information includes an account name, profile information, and posted information.

### Supplementary Note 38

A non-transitory computer readable medium storing a program for causing a computer to:
extract, based on input account information of an account, characteristics of a user of the account; and
generate, based on the input account information and the extracted characteristics of the user, an account name of a retrieval query for retrieving the account information from social media information.

### Supplementary Note 39

The non-transitory computer readable medium according to Supplementary note 38, wherein the account information includes an account name, profile information, and posted information.

Reference Signs List

| | |
|---|---|
| 1 | ACCOUNT MATCHING SYSTEM |
| 2 | ACCOUNT RETRIEVAL SYSTEM |
| 10 | COMPUTER |
| 11 | PROCESSOR |
| 12 | MEMORY |
| 100 | QUERY GENERATION APPARATUS |
| 101 | ACQUISITION UNIT |
| 102 | GENERATION UNIT |
| 110 | ACCOUNT NAME CANDIDATE GENERATION UNIT |
| 111 | ACCOUNT NAME GENERATION UNIT |
| 112 | DEGREE OF SIMILARITY CALCULATION UNIT |
| 120 | CANDIDATE FILTERING UNIT |
| 121 | CHARACTERISTIC PARAMETER ACQUISITION UNIT |
| 122 | RETRIEVAL QUERY CONTROL UNIT |
| 123 | DEGREE OF INFORMATION LITERACY CALCULATION UNIT |
| 124 | DEGREE OF FAME ACQUISITION UNIT |
| 125 | NAME USAGE RATE ACQUISITION UNIT |
| 126 | CHARACTERISTIC VECTOR EXTRACTION UNIT |
| 130 | PRIORITY CONTROL UNIT |
| 131 | PRIORITY DETERMINATION UNIT |
| 140 | CHARACTERISTIC EXTRACTION UNIT |
| 150 | ACCOUNT NAME GENERATION UNIT |
| 200 | ACCOUNT COLLECTION APPARATUS |
| 201 | ACQUISITION UNIT |
| 202 | RETRIEVAL UNIT |
| 300 | ACCOUNT MATCHING APPARATUS |
| 301 | CALCULATION UNIT |
| 302 | DETERMINATION UNIT |
| 400 | SOCIAL MEDIA SYSTEM |

What is claimed is:

1. A system comprising:
at least one memory storing instructions, and
at least one processor configured to execute the instructions stored in the at least one memory to;
generate an account name of a retrieval query based on input account information of an account; and
retrieve, by using the generated retrieval query, account information of an account name corresponding to the account name of the retrieval query from social media information.

2. The system according to claim 1, wherein the account information includes an account name, profile information, and posted information.

3. The system according to claim 1, wherein the at least one processor is further configured to execute the instructions stored in the at least one memory, in the generating of the retrieval query, to:
generate a plurality of account name candidates serving as candidates for the retrieval query based on the input account information; and
filter the plurality of generated account name candidates based on characteristics of a user of the account acquired from the input account information.

4. (canceled)

5. The system according to claim 3, wherein the at least one processor is further configured to execute the instructions stored in the at least one memory to:
generate, in the generating of the account name candidates, the plurality of account name candidates and calculate a degree of similarity between each one of the plurality of account name candidates and the account name of the input account information, and
determine, in the filtering of the account name candidates, a threshold for filtering based on the characteristics of the user, further determine, based on association between a predetermined characteristic of the user and the threshold, the threshold corresponding to the characteristic of the user.

6. The system according to claim 3, wherein the at least one processor is further configured to execute the instructions stored in the at least one memory to:
generate, in the generating of the account name candidates, the plurality of account name candidates and calculate a degree of similarity between each one of the plurality of account name candidates and the account name of the input account information, and
determine, in the filtering of the account name candidates, a threshold for filtering based on the characteristics of the user, further determine, based on a learning model that has been learned a relation between the characteristic of the user and the threshold in advance, the threshold corresponding to the characteristic of the user.

7. The system according to claim 3, wherein the at least one processor is further configured to execute the instructions stored in the at least one memory, in the filtering of the account name candidates, to:
acquire characteristic parameters indicating the characteristics of the user based on the input account information; and
filter the plurality of account name candidates based on the acquired characteristic parameters, and
the at least one processor is further configured to execute the instructions stored in the at least one memory, in the acquiring of the characteristic parameters, to calculate, as the characteristic parameter, a degree of information literacy indicating a level of information disclosure of the user.

8. (canceled)

9. The system according to claim 7, wherein the degree of information literacy is based on a percentage of items in the profile information filled out, a percentage of images of the user included in a plurality of posted images, the number of posted information items to which position information has been added, or the number of persons who appear in the plurality of posted images a plurality of times.

10. The system according to claim 7, wherein the at least one processor is further configured to execute the instructions stored in the at least one memory, in the acquiring of the characteristic parameters, to acquire a degree of fame of the user as the characteristic parameter.

11. The system according to claim 10, wherein the degree of fame is based on the number of friends the user has on social media, the number of followers the user has on social media, or the number of responses made by accounts other than that of the user to posts of the user on social media.

12. The system according to claim 7, wherein the at least one processor is further configured to execute the instructions stored in the at least one memory, in the acquiring of the characteristic parameters, to acquire a name usage rate of the user as the characteristic parameter.

13. The system according to claim 12, wherein the name usage rate is based on a percentage chance that the name is used as a name included in social media account information, a percentage chance that the name is used as a name published on the Internet, or a percentage chance that the name is acquired from name statistical information.

14. The system according to claim 7, wherein the at least one processor is further configured to execute the instructions stored in the at least one memory, in the acquiring of the characteristic parameters, to extract, as the characteristic parameter, a characteristic vector indicating the characteristic of the user by a plurality of elements.

15. The system according to claim 14, wherein the plurality of elements of the characteristic vector include information indicating an attribute of the profile information, a percentage of items in the profile information filled out, a percentage of images of the user included in a plurality of posted images, the number of posted information items to which position information has been added, or the number of persons who appear in the plurality of posted images a plurality of times.

16. The system according to claim 14, wherein the at least one processor is further configured to execute the instructions stored in the at least one memory to filter the plurality of account name candidates based on the plurality of elements of the extracted characteristic vector.

17. The system according to claim 1, wherein the at least one processor is further configured to execute the instructions stored in the at least one memory, in the generating of the retrieval query, to:
generate, based on the input account information, a plurality of account names each of which serves as the retrieval query; and
set, for the plurality of generated account names, a priority for performing account matching with regard to a result of the retrieval based on the characteristics of the user of the account acquired from the input account information.

18. The system according to claim 1, wherein the at least one processor is further configured to execute the instructions stored in the at least one memory, in the generating of the retrieval query, to:
extract the characteristics of the user of the account based on the input account information; and
generate an account name of the retrieval query based on the input account information and the extracted characteristics of the user,
the at least one processor is further configured to execute the instructions stored in the at least one memory, in the generating of the account name, to determine a generation rule for generating the account name based on the extracted characteristics of the user, and generate the account name based on the determined generation rule,
the generation rule includes a rule using a co-occurrence word estimated from the characteristics of the user, and
the co-occurrence word corresponding to the characteristic of the user is estimated based on a learning model that has learned a relation between the characteristic of the user and the co-occurrence word in advance.

19-21. (canceled)

22. A query generation apparatus comprising:
at least one memory storing instructions, and
at least one processor configured to execute the instructions stored in the at least one memory to;
generate, based on input account information of an account, a plurality of account name candidates serving as candidates for a retrieval query for retrieving the account information from social media information; and
filter the plurality of generated account name candidates based on characteristics of a user of the account acquired from the input account information.

23. (canceled)

24. A query generation apparatus comprising:
at least one memory storing instructions, and
at least one processor configured to execute the instructions stored in the at least one memory to;
generate, based on input account information of an account, a plurality of account names serving as retrieval queries for retrieving the account information from social media information; and
set, for the plurality of generated account names, a priority for performing account matching with regard to a result of the retrieval based on characteristics of a user of the account acquired from the input account information.

25-27. (canceled)

28. A query generation method comprising:
generating, based on input account information of an account, a plurality of account name candidates serving as candidates for a retrieval query for retrieving the account information from social media information; and
filtering the plurality of generated account name candidates based on characteristics of a user of the account acquired from the input account information.

29-33. (canceled)

34. A non-transitory computer readable medium storing a program for causing a computer to:
generate, based on input account information of an account, a plurality of account name candidates serving as candidates for a retrieval query for retrieving the account information from social media information; and
filter the plurality of generated account name candidates based on characteristics of a user of the account acquired from the input account information.

35-39. (canceled)
